(19) United States
(12) Patent Application Publication
(10) Pub. No.: US 2010/0215832 A1
(43) Pub. Date: Aug. 26, 2010

(54) MEAT ANALOGUE WITH EXTERNAL TEXTURE

(75) Inventor: Andrew Jason Redman, Rutherglen (AU)

Correspondence Address: FULBRIGHT & JAWORSKI, LLP, 1301 MCKINNEY, SUITE 5100, HOUSTON, TX, 77010-3095, US

(73) Assignee: MARS INCORPORATED, McLean, VA (US)

(21) Appl. No.: 12/663,394

(22) PCT Filed: Jun. 13, 2008
(86) PCT No.: PCT/AU2008/000853

§ 371 Date: Feb. 15, 2010

(30) Foreign Application Priority Data
Jun. 13, 2007 (AU) 2007903168

(51) Int. Cl. A23J 1/00; A23L 1/00

(52) U.S. Cl. 426/656; 426/516

(57) ABSTRACT

A method of manufacturing an extruded meat analogue, said method including the step of holding the extrudate at ambient temperature and pressure conditions, thereby facilitating the formation of a ‘skin’ on the outer surface of the extrudate, and contraction of the cross-sectional area of the extrudate, thereby to cause said ‘skin’ to wrinkle in a manner which resembles the appearance of cooked muscle meat.

### CROSS-REFERENCE TO RELATED APPLICATIONS

This application is a national stage filing of PCT/AU2008/000853 filed on Jun. 13, 2008, claiming priority to AU Application No. 2007903168 filed on Jun. 13, 2007.

### TECHNICAL FIELD

The invention relates to the field of commercial manufacture of meat analogue products. In particular, the invention relates to an improved method for manufacturing relatively low cost carbohydrate based meat analogues having an external texture resembling real meat, and to analogues made thereby.

### BACKGROUND OF THE INVENTION

A continuing challenge for the manufacturers of commercial pet food products is to provide food for the animal which has sufficient visual appeal to the pet owner to satisfy the owner's need to feel that they are providing their pet with a wholesome and appetizing meal. This is not a straightforward task, as the raw materials available to the pet food manufacturer are typically of lower quality than human grade materials, in order to ensure that the manufacturer is able to provide the meal at a competitive price point.

Thus, the pet food manufacturer seeks, particularly in the context of dog or cat food, to produce meat analogue chunks, which mimic the appearance of premium meat, from low cost raw materials, typically protein-rich materials such as meat offcuts and organs, for which there are a number of possible processes.

However, where the pet food product is aimed at the very ‘budget conscious’ segment of the market, who are characterized by selection of lower-cost pet foods formulations, the pet food manufacturer is obliged to minimize the inclusion of meat or other protein-rich materials, in favor of plant or cereal materials in order to further minimize the formulation cost of the food.

This presents a further challenge to the pet food manufacturer, as it is typically more difficult to make low-protein materials resemble meat products. One approach taken in the past involves the extrusion cooking of a mixture of cereal proteins, such as soy protein or wheat gluten, which produces a striated internal texture in the extrudate. When cut open, the internal texture bears a resemblance to muscle meat.

However, as this extrudate needs to be cut open in order to actually reveal the ‘meaty’ texture, there remains a need to produce a relatively low-protein meat analogue chunk which has a greater resemblance to muscle meat at its external surface, so that its ‘real food’ appearance is evident to the pet owner immediately upon opening the package, and without obliging the pet owner to manipulate the food unduly, which they would be unlikely to do. Furthermore, the need to use functional protein to create the internal texturization results in meat analogues with higher raw material costs.

It is an object of the present invention to provide a relatively low-protein pet food component having an external appearance more closely resembling muscle meat than those of the prior art.

### BRIEF SUMMARY OF THE INVENTION

According to one aspect of the invention, there is provided a method of manufacturing a meat analogue, said method including the steps of:

mixing constituent materials, said materials containing between about 5% and about 40% protein by mass;

feeding said mixture into an extrusion cooker having extrusion orifices of a known cross-sectional area;

processing said mixture in said extrusion cooker to a predetermined temperature and pressure, said temperature and pressure selected to cause said processed mixture to expand to at least twice the cross-sectional area of said extrusion orifices;

extruding said mixture from said cooker via extrusion orifices into ambient temperature and pressure, whereupon the cross-sectional area of the extruded material (extrudate) expands to at least twice the cross-sectional area of said extrusion orifices;

holding the extrudate at ambient temperature and pressure conditions, thereby facilitating the formation of a ‘skin’ on the outer surface of the extrudate, and contraction of the cross-sectional area of the extrudate, thereby to cause said ‘skin’ to wrinkle in a manner which resembles the appearance of cooked muscle meat. It is thought that this ‘skin’ may be formed as a result of a propensity of the protein in the formulation to tend to agglomerate at the surface of the piece, as a result of this process.

Preferably, the protein content of said materials is between about 10% and about 30% by mass.

Preferably, a compressive force is applied to the extrudate following contraction of said extrudate upon cooling, thereby to enhance to formation of said wrinkled appearance of the ‘skin’. This may include cutting the extrudate via any of the extrudate cutting techniques well-known in the art.

In addition, or alternatively, the external texturisation of the extrudate may be enhanced by crimping the extrudate following contraction and compression of said extrudate upon cooling. The crimping force may be applied by compressive rollers, by vacuum shrinking or by any other suitable means.

Best results have been observed where pressure and temperature conditions in the extrusion cooker are selected to cause said processed mixture to expand to between twice and three times the cross-sectional area of said extrusion orifices.

Advantageously, said constituent materials contain between about 15% and about 25% protein by mass and between about 55% and about 65% cereal by mass. A well-performing formulation of said constituent materials includes about 62% cereal; about 25% emulsified meat or meat by-product; and about 8% humectant. Preferred sources of the protein are comminuted liver, poultry viscera and beef hearts.

In another aspect of the invention, there is provided a meat analogue product produced by any method as defined above.

In another aspect of the invention, there is provided a meat analogue product containing between about 5% and about 40% protein by mass, and having an outer surface which has a wrinkled appearance, wherein the bulk of the mass of the analogue consists substantially of a matrix of starch and protein, and wherein the surface of the analogue has a higher proportion of protein than is present in the centre of the analogue. This is the physical structure which is associated with analogues produced by the method described above.

Now will be described, with reference to the figures, a specific, preferred but non-limiting embodiment of the invention.

### BRIEF DESCRIPTION OF THE DRAWINGS

FIG. 1 is a photograph of an extrusion cooker nozzle which may be employed to extrude the low-protein materials which forms the chunk according to the invention.

FIG. 2 is an alternative view of the nozzle shown in FIG. 1.

FIG. 3 is a photograph of a number of relatively low-protein meat analogue chunks according to the invention.

### DETAILED DESCRIPTION OF THE INVENTION

The present invention is herein exemplified by the following process and the resulting product.

The fundamental processes employed are well known to persons skilled in the art. The invention resides in the particulars of the formulation to produce a relatively low-protein meat analogue product suitable for inclusion in a pet food product, and in the process conditions and equipment settings chosen to produce that product.

The formulation of the raw materials is summarized below in table 1.

TABLE 1

| Component | % by Mass |
|---|---|
| Rice | 66.66 |
| Liver | 19.05 |
| Glycerol | 7.62 |
| Salt | 3.33 |
| Vegetable Oil | 1.91 |
| Potassium Chloride | 0.95 |
| Potassium Sorbate | 0.27 |
| Citric Acid | 0.10 |
| Red Colour | 0.09 |
| Antioxidant | 0.02 |

The liver is prepared by grinding through a 3 mm holeplate. The liver provides a particular advantage in the formulation in that it provides the structure for the heated steam and gas inside the extrudate to remain inside the extrudate as it exits the extrusion cooker, and does not tend to flash off upon exiting the die plate. Rice has been found to provide a particularly good source of carbohydrate.

All of the materials are then blended in a ribbon blender or equivalent mixer and transferred to the feed hopper of the extrusion cooker.

In this case the extrusion cooker used is a Werner and Pfleiderer C58 twin screw extruder. The screw profile is outlined in table 2 below.

TABLE 2

| | | | | Cumulative |
|---|---|---|---|---|
| Number of Screw | Element | | | Length |
| Elements | Length (mm) | Direction | Type | (mm) |
| 19 | 75 | Forward | Convey | 1425 |
| 2 | 15 | Forward | Convey | 1455 |
| 1 | 15 | Reverse | Convey | 1470 |
| 2 | 75 | Forward | Convey | 1620 |
| 1 | 15 | Forward | Convey | 1635 |
| 1 | 15 | Reverse | Convey | 1650 |
| 2 | 75 | Forward | Convey | 1800 |
| 1 | 15 | Forward | Convey | 1815 |
| 1 | 15 | Reverse | Convey | 1830 |
| 1 | 75 | Forward | Convey | 1905 |
| 1 | 58 | Forward | Kneading | 1963 |
| 1 | 58 | Reverse | Kneading | 2021 |
| 1 | 43 | Forward | Convey | 2064 |
| 1 | 15 | Reverse | Convey | 2079 |
| 1 | 43 | Forward | Convey | 2122 |
| 1 | 15 | Reverse | Convey | 2137 |
| 1 | 43 | Forward | Convey | 2180 |
| 1 | 15 | Reverse | Convey | 2195 |
| 2 | 75 | Forward | Convey | 2345 |
| 2 | 36 | Forward | Comp | 2417 |

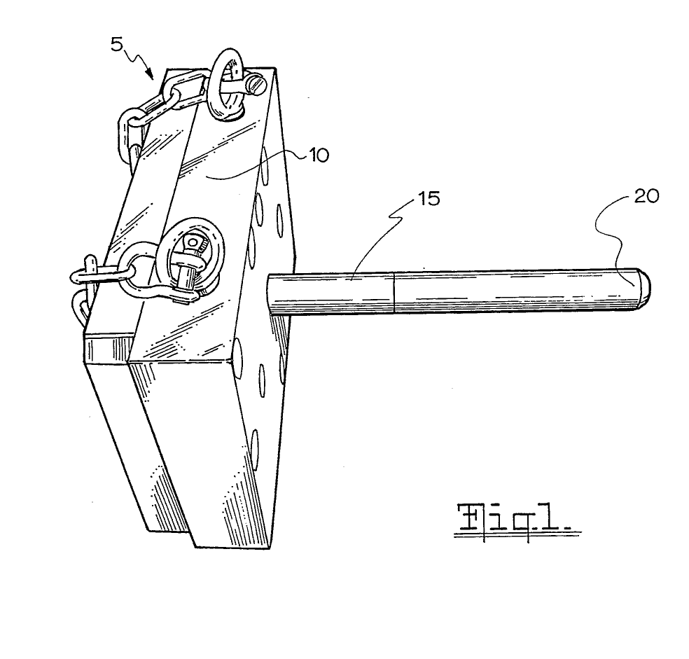

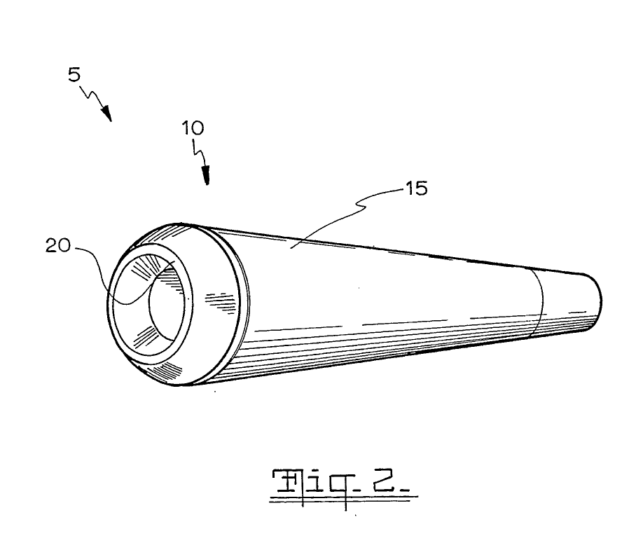

The die plate used in this particular example is illustrated in FIGS. 1 and 2. The die plate 5 includes a heavy steel plate 10, which is affixed to the outlet of the extruder (not shown). It includes a single circular hole with a 10 mm diameter, through which the pressurized extrudate passes into an elongate tubular nozzle 15. The 10 mm internal diameter is maintained throughout the nozzle 15, which ends with a 10 mm orifice 20, from which the extrudate emerges.

It is to be understood that the precise dimensions of the die plate orifices are not critical per se to the working of the invention.

Typical running conditions for the extrusion cooker are summarized below in table 3.

TABLE 3

| | | |
|---|---|---|
| Mass Feed Rate | 30-200 | kg/hr |
| Barrel 8 Temperature | 40-60° | C. |
| Barrel 9 Temperature | 50-80° | C. |
| Barrel 10 Temperature | 40-70° | C. |
| Screw speed | 200-500 | rpm |
| Screw Torque | 70-90 | Nm |
| Barrel Pressure | 19.4 | Bar |
| Specific Mechanical | 180-220 | kWh/kg |
| Energy | | |
| Final Barrel Temperature | >110° | C. |

| | |
|---|---|
| Cooling water | Chilled water to |
| | Barrel 10 |

These conditions will cause the starch in the rice to gelatinize in the extruder barrel, which is critical to the formation of a coherent extrudate, given the relatively low protein content.

This produces an extrudate which expands to a cross-sectional area of approximately 2 to 3 times the cross-sectional area of the die plate orifice 20. Upon coming into contact with the ambient air a ‘skin’ is formed at the outer surface of the extrudate, due to retrogradation of the gelatinized starch and to the action of the liver protein in the extrudate structure.

As the extrudate cools in ambient conditions, the heated gas and steam remains inside the extrudate and expansion recedes due to cooling of the expanded gases inside the extrudate. However, as the skin has formed at the surface, the surface cannot contract. This forces the skin to crease and ‘wrinkle’. This wrinkling effect produces the desired ‘meat-like’ appearance on the outer surface of the extrudate.

Typically, the extrudate would be cut to length at this point in the process, by using any one of a number of extrudate cutting techniques well known in the art, e.g. rotating knives.

Alternatively, the wrinkling effect may be enhanced by further processing. For example, the extrudate rope, while cooling, may be passed through co-operating crimping rollers, which may have uneven surfaces. This would produce uneven crushing of the cooling extrudate, which contributes to the production of the ‘meat-like’ appearance of the meat analogue.

Other such processes may be employed to enhance the wrinkling effect, such as vacuum shrinking.

Microscopy studies carried out on the structure of the internal and ‘skin layer’ of the analogue indicate that the analogue is made up substantially of a matrix of protein, fat and starch. In particular, it has been observed that the concentration of agglomerated proteins, as well as fat, tends to be more higher at the skin layer than is found in the central or bulk of the analogue mass. It is theorized that this concentration of the proteins in particular at the surface or skin contributes to the particularly ‘authentic’ surface appearance of the extrudate.

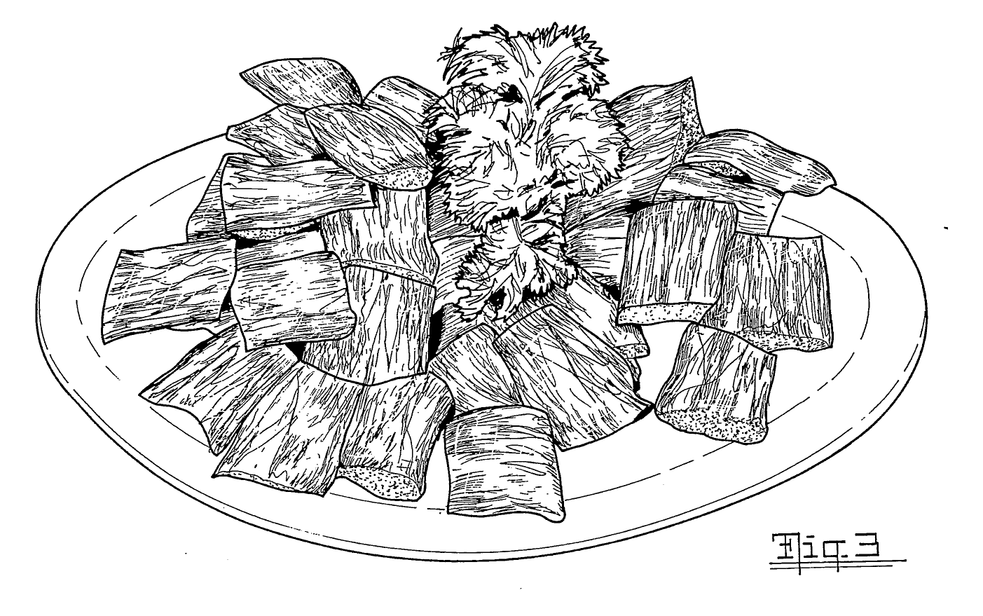

As illustrated in FIG. 3, the final meat analogue chunks produced according to the above process have a very ‘meaty’ looking outer appearance, which makes them highly aesthetically suitable for inclusion in a commercial prepared pet food.

The foregoing example is merely one way in which the inventive concept can be applied. Other embodiments of the invention are conceivable which would remain within the spirit and scope of the invention.

1. A method of manufacturing a meat analogue, said method including the steps of:
mixing constituent materials, said materials containing between about 5% and about 40% protein by mass;
feeding said mixture into an extrusion cooker having extrusion orifices of a known cross-sectional area;
processing said mixture in said extrusion cooker to a predetermined temperature and pressure selected to cause said processed mixture to expand to at least twice the cross-sectional area of said extrusion orifices;
extruding said mixture from said cooker via extrusion orifices into ambient temperature and pressure, whereupon the cross-sectional area of the extruded material (extrudate) expands to at least twice the cross-sectional area of said extrusion orifices;
holding the extrudate at ambient temperature and pressure conditions, thereby facilitating the formation of a ‘skin’ on the outer surface of the extrudate, and facilitating contraction of the cross-sectional area of the extrudate, thereby to cause said ‘skin’ to wrinkle in a manner which resembles the appearance of cooked muscle meat.

2. The method of claim 1, further including the step of applying a compressive force to the extrudate following contraction of said extrudate upon cooling, thereby to enhance the formation of said wrinkled appearance of the ‘skin’.

3. The method of claim 1, further including the step of crimping the extrudate following contraction and compression of said extrudate upon cooling.

4. The method of claim 2, wherein said compressive force is applied by compressive rollers.

5. The method of claim 1, wherein said pressure and temperature conditions in the extrusion cooker are selected to cause said processed mixture to expand to between twice and three times the cross-sectional area of said extrusion orifices.

6. The method of claim 1, wherein the protein content of said materials is between about 10% and about 30% by mass.

7. The method of claim 1, wherein said constituent materials contain between about 15% and about 25% protein by mass.

8. The method of claim 7, wherein the protein is substantially provided by one or more materials selected from the group consisting of comminuted liver, poultry viscera and beef hearts.

9. The method of claim 7, wherein said constituent materials contain between about 55% and about 65% cereal by mass.

10. The method of claim 7, wherein said constituent materials contain about 62% cereal; about 25% emulsified meat or meat by-product; and about 8% humectant.

11. The method of claim 1, wherein said constituents contain carbohydrate materials derived from rice.

12. A meat analogue product produced by the method comprising the steps of:
mixing constituent materials, said materials containing between about 5% and about 40% protein by mass;
feeding said mixture into an extrusion cooker having extrusion orifices of a known cross-sectional area;
processing said mixture in said extrusion cooker to a predetermined temperature and pressure selected to cause said processed mixture to expand to at least twice the cross-sectional area of said extrusion orifices;
extruding said mixture from said cooker via extrusion orifices into ambient temperature and pressure, whereupon the cross-sectional area of the extruded material (extrudate) expands to at least twice the cross-sectional area of said extrusion orifices;
holding the extrudate at ambient temperature and pressure conditions, thereby facilitating the formation of a ‘skin’ on the outer surface of the extrudate, and facilitating contraction of the cross-sectional area of the extrudate, thereby to cause said ‘skin’ of the formed meat analogue to wrinkle in a manner which resembles the appearance of cooked muscle meat.

13. A meat analogue product comprising: between about 5% and about 40% protein by mass, and having an outer surface which has a wrinkled appearance, wherein the bulk of the mass of the analogue consists substantially of a matrix of starch and protein, and wherein the surface of the analogue has a higher proportion of protein than is present in the centre of the analogue.

14. The meat analogue of claim 13, wherein the starch is derived from rice.

15. (canceled)

16. (canceled)
